(19) United States
(12) Patent Application Publication
(10) Pub. No.: US 2011/0184874 A1
(43) Pub. Date: Jul. 28, 2011

(54) LEAD ALLOCATION IN REAL ESTATE APPLICATIONS USING INCOMING CLIENT'S GEOGRAPHIC POSITION

(75) Inventors: James Wilson, Lafayette, CA (US); Jeffrey McNeill, Sunnyvale, CA (US); Michael Davis, Pleasant Hill, CA (US); Samuel Douglass, Berkeley, CA (US)

(73) Assignee: ZipRealty, Inc., Emeryville, CA (US)

(21) Appl. No.: 13/027,136

(22) Filed: Feb. 14, 2011

Related U.S. Application Data
(60) Provisional application No. 61/428,753, filed on Dec. 30, 2010.

(51) Int. Cl. G06Q 50/00

(52) U.S. Cl. 705/313

(57) ABSTRACT

Disclosed herein is a lead allocation methodology that relates to a scenario where a client is best served by being assigned to an agent located in close geographic proximity to the client's current geographic position. In order to best cater such interests, the real estate service may perform the lead allocation by identifying current the geographic position of the client, and then comparing that position against current geographic positions of agents in geographic proximity to the client. In some instances, the real estate service identifies a certain number of most proximate agents and relays the client's request to such agents. When one of the agents responds to the request, that agent is assigned to the client. In some instances, the service then informs the client about the assignment, and also, in some instances, indicates an expected arrival time of the agent at the client's present location.

### CROSS REFERENCE TO RELATED APPLICATIONS

This application claims priority to U.S. Provisional Application No. 61/428,753, entitled REAL ESTATE MANAGEMENT APPLICATIONS filed Dec. 30, 2010, which is hereby incorporated by reference in its entirety.

This patent application is related to the technologies described in the following patents and applications, all of which are incorporated herein in their entireties:

U.S. patent application Ser. No. ______, entitled METHODS AND SYSTEMS FOR PRIORITIZING CALL INITIATION IN A REAL ESTATE MANAGEMENT APPLICATION, filed concurrently herewith;
U.S. patent application Ser. No. ______, entitled METHODS AND SYSTEMS FOR REAL ESTATE AGENT TRACKING AND EXPERTISE DATA GENERATION, filed concurrently herewith;
U.S. patent application Ser. No. ______, entitled METHODS AND SYSTEMS FOR TRANSMITTING LOCATION BASED AGENT ALERTS IN A REAL ESTATE APPLICATION, filed concurrently herewith;
U.S. patent application Ser. No. ______, entitled LEAD ALLOCATION IN REAL ESTATE APPLICATIONS USING DYNAMIC AGENT ALLOCATION WEIGHTAGES, filed concurrently herewith;
U.S. patent application Ser. No. ______, entitled VIRTUAL BIDDING PLATFORM FOR LEAD ALLOCATION IN REAL ESTATE APPLICATIONS, filed concurrently herewith.

### FIELD

The present invention generally relates to the field of electronic real estate management applications. More particularly, the present invention relates to methods and systems for assigning a client to a particular real estate agent based on certain agent or client characteristics.

### BACKGROUND

The rapid growth in digital and Internet technology has revolutionized the real estate industry. A vast majority of real estate transactions are performed online. Examples of such real estate transactions may include a client searching through online property listings, a real estate agent scheduling viewing-tours with clients, an agent drafting and transmitting offers for purchase of property, etc. In typical online real estate service scenarios, the real estate service may operate a large scale operation, where service is provided using real estate agents spread across various geographic locations. Lead allocation, as defined herein, generally refers to a process by which an incoming client is assigned to one of multiple real estate agents associated with the real estate service.

In prior art systems, an incoming client may utilize a web service operated by the real estate service to search property listings in a particular geographic location. The client may then request a “showing” or a tour of one or more properties. In some instances, the client may require services of a real estate agent event to discuss a particular location or availability of listings in a particular location. In some instances, the real estate service may want to initially pair the incoming client with a particular real estate agent to ensure that the incoming client eventually establishes a rapport with a particular agent to ensure that the client stays committed to purchasing a property using the real estate service. In some instances, a client may demand an immediate showing of a property while located at the property (e.g., using a mobile application offered by the real estate service). In such instances, the lead allocation would have to be based on agents currently available in a geographic proximity. In some instances, based on the type of property they are looking for or other such factors, some incoming clients may represent a particularly significant business prospect to some clients. In such instances, several real estate agents may indicate an interest in being assigned to the client.

Allocating or assigning an incoming client with an appropriate real estate agent is important for establishing long-term relationships with the client and for ensuring business productivity. Presently existing systems do not comprehend the various nuances and parameters that need to be considered for effective lead allocation. Typical prior art systems simply allocate clients based on a geographic criterion or agent availability. For example, when an incoming client requests a property tour of a house in Mountain View, Calif., present systems would typically allocate the incoming client to an agent that is assigned to tour houses in Mountain View, Calif. None of the client specific or agent specific interests or capabilities is taken into account. This may lead to mismatched lead allocation, resulting in poorer business productivity for the real estate service in the longer run.

Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE DESCRIPTION

One embodiment of the lead allocation methodologies discussed herein relates to a scenario where a client is best served by being assigned to an agent located in close geographic proximity to the client's current geographic position. In one example, such a scenario may occur when the client is located at or near a specific property (e.g., a property listed under MLS), and the client would like an immediate showing of the property. In another example, such a scenario may occur when a client expresses an interest in immediately meeting, in-person, a real estate agent associated with the real estate service in order to commence touring or otherwise establish an association with the real estate service. In order to best cater such interests, the real estate service may perform the lead allocation by identifying current the geographic position of the client, and then comparing that position against current geographic positions of agents in geographic proximity to the client. As discussed above, the geographic positions of the client and the agents may be determined using GPS or other location determining capabilities of the agents' or client's mobile devices.

In some instances, the real estate service identifies a certain number of most proximate agents and relays the client's request to such agents. When one of the agents responds to the request, that agent is assigned to the client. In some instances, the service then informs the client about the assignment, and also, in some instances, indicates an expected arrival time of the agent at the client's present location based on the assigned agent's present location. In some instances, instead of basing the search on the client's present geographic position, the search may instead be based on a specific address provided by the client.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 and the following discussion provide a brief, general description of a representative environment in which the invention can be implemented;

FIGS. 2A-2B depict exemplary illustrations of a real estate management application for use by a real estate agent;

FIG. 3 depicts an exemplary display confirming an MLS match to a real estate agent's present geographic location;

FIGS. 4A-4C depict embodiments illustrating mechanisms that utilize the expertise information gathered for a given real estate agent;

FIG. 5 is a flow diagram depicting a high level process for tracking a real estate agent's property visits;

FIGS. 6A-6B depict exemplary illustrations of a location alert application;

FIG. 7 is an example of a networking website with a display of the alert transmitted by the real estate service;

FIG. 8 is a high level flow diagram illustrating a process that the real estate service utilizes to issue location alerts;

FIGS. 9A and 9B illustrate a visual embodiment of a client user interface of the real estate application for demanding an agent based on present location;

FIGS. 10A and 10B illustrates an embodiment of the real estate management application to respectively inform the agent of a client request and to inform the client of assignment to a particular agent;

FIG. 11 is a flow diagram illustrating a process by which a client may demand an agent based on the client's present location;

FIG. 12A illustrates performance indicators used in calculating a real estate agent's allocated weightage;

FIG. 12B illustrates a weightage scaling of the performance indicator scores during lead allocation;

FIG. 12C is a flow diagram that depicts an example of lead allocation based on a ranking of allocation weightages associated with the agents;

FIG. 12D is a flow chart depicting an exemplary process for allocating leads utilizing the virtual lead allocation methodologies;

FIG. 12E is an example of a virtual platform of the real estate service management application that enables an agent to place a bid; and

FIG. 12F illustrates indicators utilized for determining a client weightage rating.

FIG. 13 is a high-level block diagram showing an example of the architecture for a computer system.

The headings provided herein are for convenience only and do not necessarily affect the scope or meaning of the claimed invention.

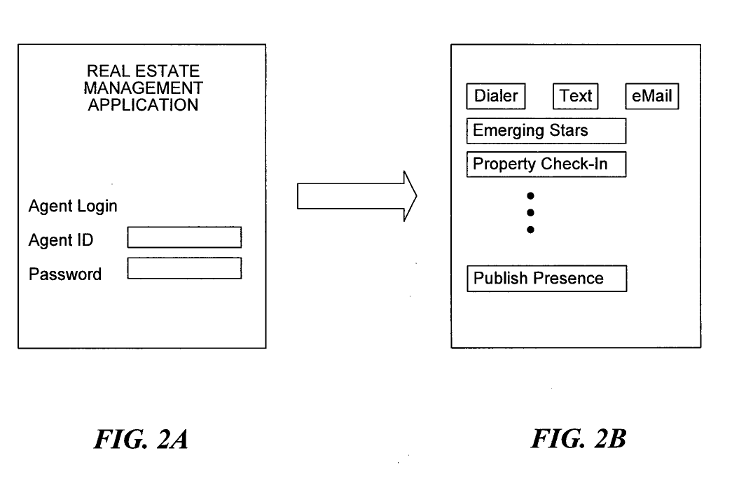

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

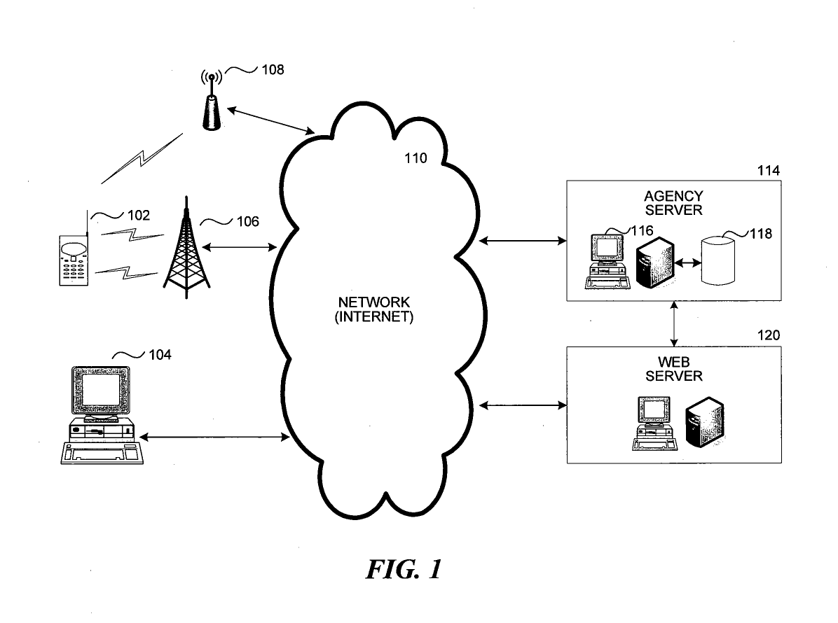

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 102, the personal computer 104, etc.) to connect to an agency server 114 through the network 110. In one embodiment, the agency server 114 comprises a server computer 116 coupled to a local database 118. The term “agency server” as indicated herein, refers to a server station or other computing apparatus capable of hosting a web service that is accessible by other computing systems (e.g., the personal computer 104) through, for example, the Internet.

In embodiments, the agency server 114 illustrated in FIG. 1 operates, or offers for operation, an electronic real estate management application. The term “electronic real estate management application” (or simply, a “real estate service”) as indicated herein, refers to a suite of operations or applications that may include, for example, a management application for real estate agents. As will be explained in further detail herein, such an application would allow the agent to, for example, manage and coordinate user profiles or potential buyers (or clients) engaged with the agent for the purpose of purchasing real estate in a particular location, managing offer submission and contract generation, managing and overseeing client activity, establish communication with clients through one or more communication media (e.g., embedded telephone application, embedded text or email application, etc.), track client location, publish agent's present geographic location, etc. The agency server 114 may utilize the associated database 118 to store and manage contact information and all other data related to the above mentioned examples.

In embodiments, the functionalities of the real estate service may be processed entirely within the agency server 114, operated via a graphical user interface from the user's computing device (102 or 104). For example, the agency server 114 may offer a web based interface to the various functionalities, allowing a user to control or operate the functionalities using web based interfaces via the user's computing device. In such instances, the agency server 114 handles all database related operations (e.g., retrieving the contacts associated with an agent, retrieving user profile information, retrieving previously saved contracts and other paperwork for a particular client, etc.) in a client-server architecture, allowing the computing device to receive and display such information. In embodiments, however, it is understood that the functionalities of the real estate service described herein may be handled and operated entirely in a stand-alone manner entirely from the computing device. It is further understood that the exemplary functionalities described herein may be performed in any other architecture as may be understood by a person of ordinary skill in the art.

As indicated in the example above, in some instances, the agency server 114 may also operate as a web server to enable the functionalities of the real estate service to be offered over a local network or the Internet. In such instances, the agency server 114 may operate additionally as a web server or may be coupled to a separate web server 120 to provide the web functionalities. Further, as shown in FIG. 1, the personal computing devices (e.g., 102, 104) and the agency server 114 are connected through the network 110 to one or more web servers (e.g., web server 120).

### Agent Tracking and Expertise Data Generation

As will be explained in additional detail below, in one embodiment, the real estate service offers a management application for real estate agents to, for example, coordinate and manage real estate activities related to their clients. In one example, such a real estate application includes a feature that enables the real estate service to track an agent's touring history and extract corresponding expertise information for the agent. Traditionally, the agents are engaged in several tours each day, either touring different houses with the same client, or touring different houses with different clients, or both. It is often cumbersome for the agents to record and keep track of the houses they actually visited. An agent would have to painstakingly keep a log of all the places she visited and provide such information to a real estate service management application. Because of the number of tours an agent does in a day, the agent may also potentially miss entering information regarding some of the houses the agent may have toured.

Accurately tracking and recording this information is important for several reasons. First, when an agent tours, for example, several houses in a given neighborhood, or gains a specialty in touring a certain type of houses (e.g., specialty in touring seaside or riverfront houses), such information can be gainfully advertised to potential clients as the agent's expertise in such fields. Additionally, when a potential consumer is in the process of selecting an agent, such expertise information would be beneficial as at least one of the factors in helping the client make a choice on an agent.

Apart from tracking the agents' tours or for expertise reasons, in some instances, a company operating the real estate management service may want to track the agents' tours for other reasons. For example, the agents' compensation or reimbursement may be tied to the number of tours the agent does. In other instances, the tracking information may be useful for internal agent evaluation purposes. Automatic verification and tracking capabilities would therefore be beneficial for a multitude of reasons.

In one embodiment, the real estate management application offers a “property check-in” feature that enables the agent to automatically check-in at each property location. In an illustrative embodiment, subsequent to entering a given property, the agent selects the check-in feature in the mobile real estate service application (i.e., an application offered via the agent's mobile computing device). Subsequently, the real estate service determines a present geographic location of the agent utilizing, for example, the mobile device's geo-location capabilities (e.g., inbuilt GPS capabilities). Using this location, the real estate service searches for MLS listed property locations at or near the user's location. Using this information, the real estate service determines that the agent is currently at a particular property for touring that property. As will be explained below, the real estate service may employ additional verification mechanisms to ensure accuracy of such a determination. Subsequently, the real estate service extracts MLS information related to the specific property that the user is located at. MLS (or Multiple Listing Service), as defined herein, refers to listing information provided for real estate properties. An MLS listing for a property typically includes extensive information about the property such as, for example, property type (e.g., house, condo, town house, etc.), asking price, address information, location information (e.g., county, neighborhood, etc.), views (e.g., oceanfront, city view, etc.), etc. In one embodiment, the real estate service extracts this MLS information, and uses such information to add to or update an “expertise entry” associated with the agent.

In some instances, the expertise entry may just be a data structure maintained in the database associated with the agency server to keep track of the agent's expertise. In exemplary embodiment, the expertise entry could include several variables. For example, the expertise entry could include variables such as “house type,” “neighborhood,” etc. Each of these variables could have several sub-categories. For example, a house type could include subcategories such as a condo, an apartment, etc. Typically, the sub-categories are tied to MLS listing terms. Accordingly, when an agent is tracked to have visited a house that is identified as an “apartment” (i.e., based on the MLS listing information extracted for the house), the real estate service then increments a tracking value maintained for the “apartment” subcategory under the house type variable. Extending this process to other categories and other variables, the tracking entry enables the real estate service to maintain accurate expertise history for each agent. This expertise information may be utilized and presented in a variety of manners, some of which will be discussed in the following sections.

FIGS. 2A-2B depict exemplary illustrations of a real estate management application for use by a real estate agent. In one embodiment, an agent invokes the real estate management application (real estate application) 210 on a computing device 104. As illustrated in FIG. 2A, the real estate application first requires the agent to login to a service account associated with the agent. Upon logging in, the real estate application 210 presents an overview page, presenting the various functionalities available to the use, as illustrated in FIG. 2B. It is noted that FIG. 2B is merely an exemplary depiction of some of the potential features made available to the agent, and is not intended as a comprehensive embodiment. In the example of FIG. 2B, the agent is presented with a list of contacts associated with the agent. In one example, the real estate service 210 groups the contacts under one or more categories. For example, a first category 260 groups all contacts that have previously been designated as emerging stars. As described herein, an emerging star could be a client that shows immense potential value in purchasing a property in the immediate future, or one that purchases real estate properties on a regular basis, or simply any client that is attractive to the agent from a business perspective.

In embodiments, the overview page may also include a “property check-in” feature, enabling the agent to check-in to a property the agent is currently located at. As discussed above, this information will be useful in tracking and generating expertise information for the agent. Typically, an agent would check-in after entering the property that the agent wishes to tour. The agent would conventionally enter the apartment by means of a lockbox mechanism. Functionalities of such a lockbox mechanism are well understood by people of ordinary skill in the art. The agent typically has a lockbox “key” (typically an electronic device) that the agent uses to retrieve the property's actual physical key. Subsequent to entering the property, the agent activates the property check feature 262 of the mobile real estate management application service. Upon enabling this feature, and as discussed above, the real estate service determines a current geographic location of the user (e.g., by tapping into the resources offered by the mobile device) and attempts to map it to a specific MLS entry at the same location.

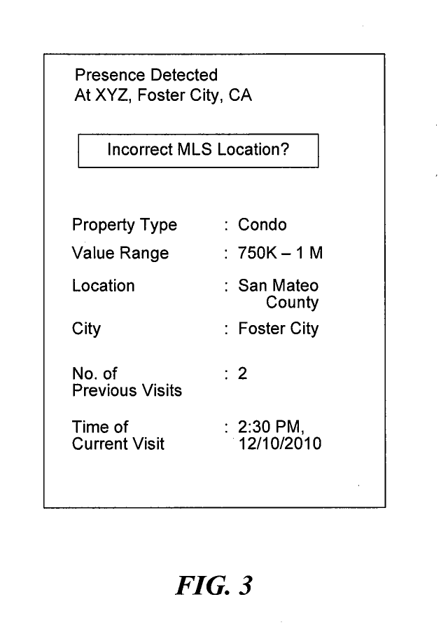

The real estate service may perform this matching in one of several ways. In one example, if the real estate service identifies only one MLS entry at the immediate vicinity of the identified location, it then automatically assigns that location as the specific MLS location that the agent is at. A display similar to the display illustrated in FIG. 3 may be presented to the user to confirm the match. In one example, the real estate service may simply display an indicator of the specific MLS entry to the user asking for the user's confirmation.

There may be scenarios where the real estate service identifies multiple MLS listings at the same location. For example, a single apartment building may have multiple open listings. In that scenario, for example, the real estate service may cause indicators of these MLS listings to be displayed to the agent, and assign a particular MLS entry as the current MLS location based on the agent's selection of one of the indicators.

In some instances, the real estate service may perform additional routines to ensure that the agent is actually in the specific MLS location. In one example, the real estate service may query a log of the lockbox entries and identify a most recent lockbox entry for the specific MLS location. The real estate service then verifies the most recent lockbox entry against the agent's lockbox access code to ensure that the agent is actually in the specific MLS location.

Subsequent to making a successful match, the real estate service extracts MLS information related to the specific MLS location. Examples of such MLS attributes are illustrated in FIG. 3. As discussed above, in embodiments, the real estate service maintains an expertise entry for the purpose of tracking the agent's expertise. The real estate service then identifies each attribute in the MLS information and correlates it to (or adds it to) the categories stored in association with the expertise entry. For example, if the agent visited a house that is listed at $1.2M, the real estate service correlates this to a category titled “$1M-$1.5M.” In an exemplary embodiment, the real estate service maintains a count value of each category, and increments the count value for the categories that match or correlate against the MLS information in the specific MLS location. Accordingly, the expertise entry serves to maintain the expertise and tracking history of the agent based on actual agent visits to various MLS locations.

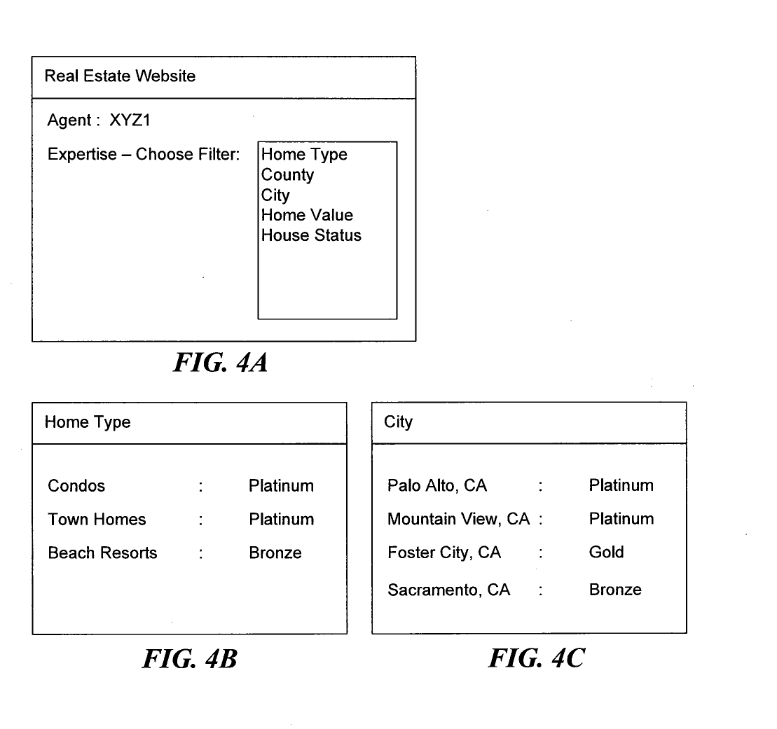

FIGS. 4A-4C illustrate embodiments of how the expertise information may be utilized. Of course, it is understood that other implementations, as understood by a person of ordinary skill in the art, to effectively utilize and display the expertise information, are also contemplated as equivalents of the techniques discussed herein. FIG. 4A provides an example of how a user navigating the real estate service's website may view an agent's expertise history. For example, after identifying a particular agent, the user chooses an “expertise filter.” The user may optionally filter the expertise results based on one of these categories (i.e., the categories maintained in association with the expertise entry). In a first example, as illustrated in FIG. 4B, the user filters results based on “home type.” The agent illustrated in this example has a platinum ranking for condos and town homes, and a bronze for beach resorts. In this example, the real estate service internally maintains definitions for each of these rankings. For example, the ranking could be: platinum for 100 or more visits within the last 6 months to properties of that category; gold for 75-100 visits within the last 6 months; and so on. Accordingly, this display gives the user an immediate idea as to the agent's expertise in dealing with condo and town home type of properties. A similar example based on city location is illustrated in FIG. 4C.

In another embodiment (not shown in FIG. 4), the real estate service could also rank all its agents based on a particular category. For example, if a user is interested in determining agents with the most expertise in houses around the Palo Alto area, the user could potentially request a listing of all agents with expertise in the Palo Alto area. Using the expertise entry maintained for each agent, the real estate service could then easily provide a listing and expertise level/ranking of each of its agents that have previously toured in the Palo Alto area.

Additionally, as discussed above, the techniques discussed herein further enable the real estate service to maintain an accurate record of locations toured/visited by the agent. The agent would not be able to alter the record as the visits and tours are automatically captured based on the agent's actual physical presence in the MLS property, and because, in some embodiments, the presence is further validated using queries to lockbox logs.

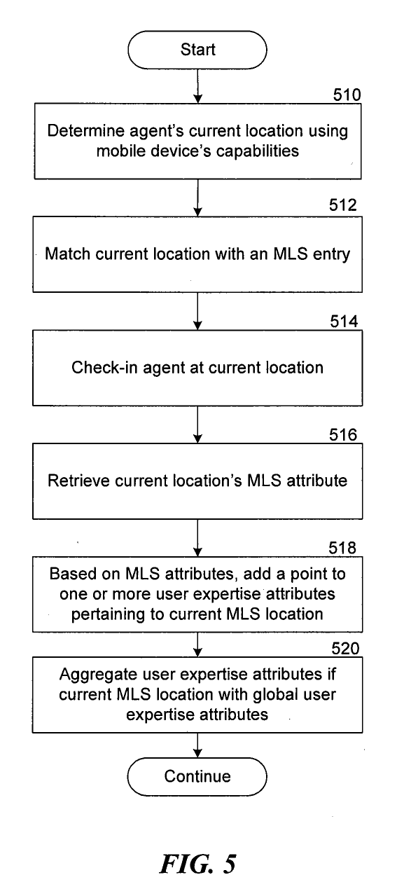

FIG. 5 is a flow diagram depicting a high level process for tracking a real estate agent's property visits. In one embodiment, the process beings at step 510, where the real estate service determines the agent's current geographic location using capabilities of the agent's mobile device. Subsequently, at step 512, the real estate service matches the agent's current location with an MLS entry relevant to the current location. Using the identified MLS location, the real estate service “checks in” the agent at the current location. In some instances, as discussed above, the real estate service may perform other verification routines (e.g., verification of one MLS location when multiple listings are identified in the same location, verification against a lockbox entry log, etc.). The process then proceeds to step 518, where the real estate service retrieves MLS attributes for the identified MLS location. Subsequently, at step 520, the real estate service aggregates the information from the MLS attributes to corresponding categories maintained in an expertise entry associated with the agent.

### Agent Location Alerts

As will be explained in additional detail below, in one embodiment, the real estate service offers a management application for real estate agents to, for example, coordinate and manage real estate activities related to their clients. In one example, such a real estate application includes a feature that enables the real estate service to automatically publish alerts relating to specific places the agent tours or visits. A real estate agent may typically have tens to hundreds of clients at any given time. With the increase in use of internet technology in real estate applications, clients may be assigned to agents even before the agent has an opportunity to get to know the client or the client's preferences. Often, when an agent visits a particular property (e.g., while touring with a particular client), the agent may recall another client who may also be interested in the property. If the agent had a sufficient history of touring with the other client, the agent may even recognize that the other client would have liked the location or the structure of the property. However, there are two factors that potentially preclude the real estate agent from being able to inform her other clients of locations that they may be interested in. First, when the agent tours several multiple locations on the same day, the features of the various properties blur in the agent's mind by the end of the day. To avoid this issue, the agent would have to inform (i.e., make a call to) her other clients right when she is visiting the location. However, while touring with her current client, out of politeness and out of business etiquette, the agent is usually unable to make a call to her other clients during the tour. Second, given the number of clients the agent may have on her roster at any given time, it is often cumbersome for the agent to remember or identify other clients that may potentially be interested in the current property. The techniques described herein, with respect to the “location alert” feature of the real estate service address these problems and provide other benefits as discussed below.

In one embodiment, when a real estate agent invokes the “location alert” option, for example, using the real estate management application installed on her mobile device, the real estate service automatically retrieves the current geographic location of the agent (e.g., using geo-location capabilities of the agent's mobile device). Using this information, the real estate service identifies a specific MLS location that the agent is currently located at. For example, the real estate service may identify the closest MLS listing to the agent's current location and identify that MLS listing as the specific MLS location of the agent. In other examples, similar to the ones discussed with respect to the expertise tracking application, the real estate service may implement a suite of operations to identify the specific MLS location of the agent. In some instances, the real estate service may also validate the specific MLS location by querying the agent's most recent lockbox access entry and matching it against the lockbox details associated with the specific MLS location.

Subsequent to identifying the specific MLS location, the real estate service identifies and retrieves MLS listing information corresponding to the specific MLS location. The real estate service also retrieves a list of the agent's clients from a database associated with, for example, the agency server.

In some instances, the real estate service maintains preference information associated with each client. In some instances, the clients may have indicated their preference in properties they desire. For example, the client may have indicated he is interested in houses in Folsom, Calif., or that he is interested in a lake-view property. In such instances, the real estate service maintains their preferences in association with their profile. In some instances, the clients may have indicated certain preferences to the agent in prior tours, and the agents could then annotate such preferences in association with the client's profile. In some instances, the client may have indicated their interest in a specific property that may have not been available for sale. In such instances, the real estate service may extract MLS information related to the unavailable house and store such preferences in association with the client's profile. In some instances, the real estate service may internally run preference routines to track the client's prior search history to identify certain preference patterns (e.g., based on price, location, etc.) and maintain such preferences in association with the client's profile. Additionally, any other process used for determining a client's preference, as understood by a person of ordinary skill in the art, may equally be applied in conjunction with the techniques discussed herein.

Returning back to the location alert feature, the real estate service identifies the agent's clients and also accesses the profile information (or at least the preference information associated with the clients' profiles). The real estate service also identifies and retrieves MLS information associated with the specific MLS location (i.e., the agent's current location). The real estate service then performs one or more operations to identify a subset of the agent's clients that may be interested in the current property. The real estate service may, for example, compare the MLS information of the current property against known client preferences from the client profile and determine the subset of targeted clients. In one example, the real estate service may identify a list of clients who previously expressed interest in the current property or in the current neighborhood. In one example, the subset of targeted clients may simply include new clients that signed up with the real estate service. In one example, the targeted subset could also just include all of the agent's clients. In one example, the targeted subset could include users currently using a client version of the mobile real estate application. Other such examples of matching the user's preferences against the current property, as understood by a person of ordinary skill in the art, may also be equally applied herein.

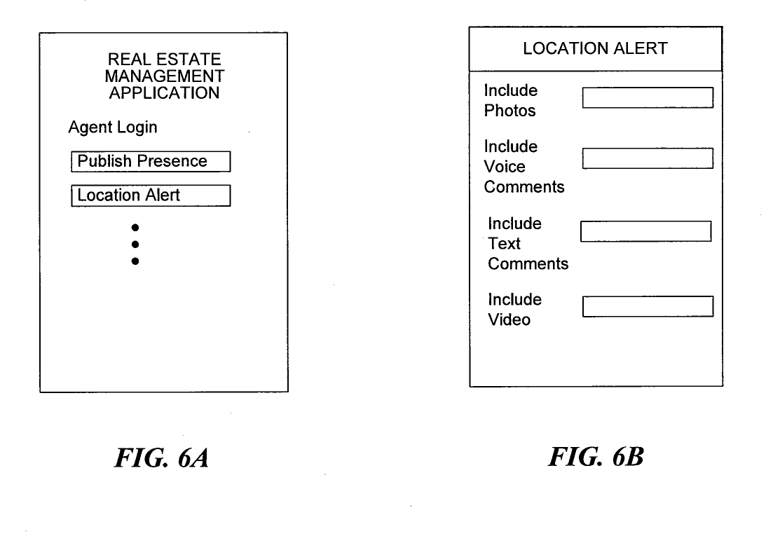

Subsequent to identifying the targeted subset of clients, the real estate service transmits an alert to the targeted subset. The alert may be sent using one or more transmission methods, depending on a variety of factors. In one example, the alert may be blasted via email or text message. In one example, the alert may be transmitted based on preferences previously established by the client. Additionally, as illustrated in FIG. 6B, the agent may also include additional information along with the alert. For example, the agent may use his mobile device to capture additional pictures and/or videos of the property. The user may also capture a personalized narrative of the property (in some instances, the narrative may be in conjunction with the video). The real estate service then incorporates all this information, along with other information about the agent and the current property, and transmits the alert to the targeted subset of clients.

In this manner, the agent is relieved of the hassle of having to identify specific clients who may be interested in a property that the agent is currently viewing. The agent simply has to activate the location alert feature, and the real estate service automatically captures information about the current location, identifies potential clients that may be interested in the current location, and blasts out personalized alerts with information that the clients would not otherwise be able to access.

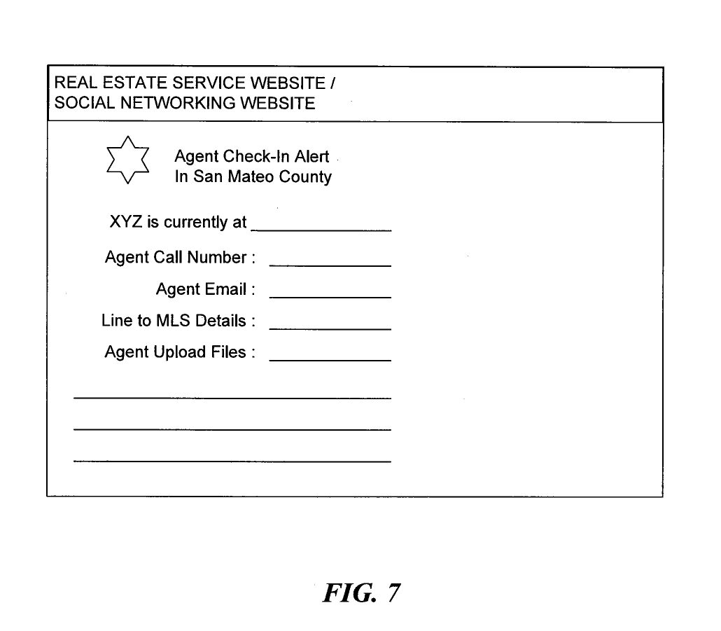

In embodiments, in addition to the transmission of above alerts, or in lieu of such alerts, the real estate service may also publish the alerts in networking websites. A networking website, as defined herein, includes any website that allows clients to access information posted by the agent. In one example, the networking website may just be a website operated by the real estate service. In another example, the networking website may be a social networking website (e.g., Facebook.com®, Twitter.com®, etc.). Here, the real estate service may have clients in the form of “followers” or “friends” that follow information posted by the real estate service. In such instances, the real estate service automatically posts the alert information on the website, with links to all the additional information uploaded by the client. In some examples, the networking website could be a third-party website, where the real estate service posts the alert information in the form of an advertisement. An example of such a posting in a networking website is illustrated in FIG. 7.

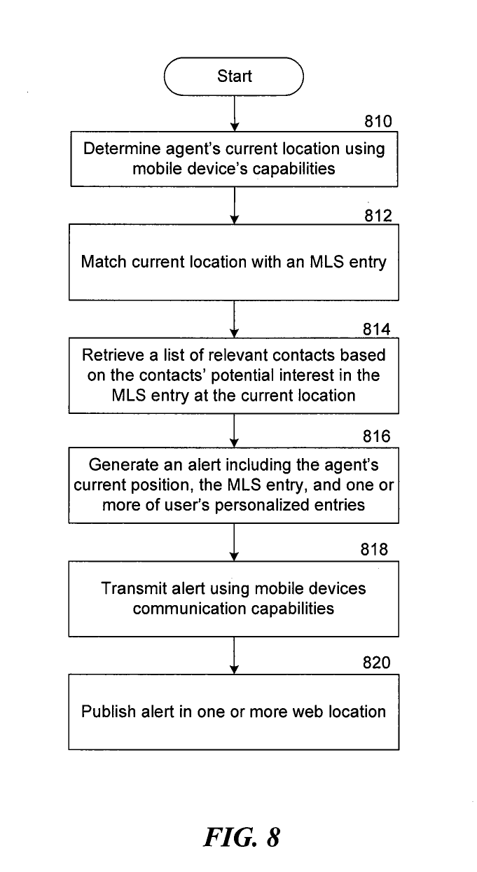

FIG. 8 is a high level flow diagram illustrating a process that the real estate service utilizes to issue location alerts. The process starts at step 810, where the real estate service determines the agent's current geographic location using the agent's mobile device. At step 812, the real estate service matches the user's geographic location with a specific MLS location. Subsequently, at step 814, the real estate service retrieves a list of the agents' clients and identifies a targeted subset of clients that may potentially be interested in the current property. At step 816, the real estate service generates an alert utilizing the information provided by the agent and blasts the alert to the targeted subset at step 818. Finally, at step 820, the real estate service optionally publishes the alert in one or more networking websites.

### Lead Allocation

As will be explained in additional detail below, in one embodiment, the real estate service offers several mechanisms for lead allocation. Lead allocation, as defined herein, generally refers to a process by which an incoming client is assigned to one of multiple real estate agents associated with the real estate service. As discussed above, in one embodiment, the real estate service may operate a large scale operation, where service is provided using real estate agents spread across various geographic locations. In instances, multiple real estate agents may be associated with a single geographic location. In other instances, even if a geographic location has multiple real estate agents, a client may be better served by a real estate agent with better expertise in purchasing a particular type of property, even if that agent is from a different geographic location.

In a typical scenario, an incoming client may utilize a web service operated by the real estate service to search property listings in a particular geographic location. The client may then request a “showing” or a tour of one or more properties. In some instances, the client may require services of a real estate agent event to discuss a particular location or availability of listings in a particular location. In some instances, the real estate service may want to initially pair the incoming client with a particular real estate agent to ensure that the incoming client eventually establishes a rapport with a particular agent to ensure that the client stays committed to purchasing a property using the real estate service. In some instances, a client may demand an immediate showing of a property while located at the property (e.g., using a mobile application offered by the real estate service). In such instances, the lead allocation would have to be based on agents currently available in a geographic proximity. In some instances, based on the type of property they are looking for or other such factors, some incoming clients may represent a particularly significant business prospect to some clients. In such instances, several real estate agents may indicate an interest in being assigned to the client.

Allocating or assigning an incoming client with an appropriate real estate agent is important for establishing long-term relationships with the client and for ensuring business productivity. Presently existing systems do not comprehend the various nuances and parameters that need to be considered for effective lead allocation. Typical prior art systems simply allocate clients based on a geographic criterion or agent availability. For example, when an incoming client requests a property tour of a house in Mountain View, Calif., present systems would typically allocate the incoming client to an agent that is assigned to tour houses in Mountain View, Calif. None of the client specific or agent specific interests or capabilities is taken into account. This may lead to mismatched lead allocation, resulting in poorer business productivity for the real estate service in the longer run. This section discusses various such methodologies for efficient and targeted lead allocation for incoming clients.

### Present Location Based Lead Allocation

A first embodiment of the lead allocation relates to a scenario where a client is best served by being assigned to an agent located in close geographic proximity to the client's current geographic position. In one example, such a scenario may occur when the client is located at or near a specific property (e.g., a property listed under MLS), and the client would like an immediate showing of the property. In another example, such a scenario may occur when a client expresses an interest in immediately meeting, in-person, a real estate agent associated with the real estate service in order to commence touring or otherwise establish an association with the real estate service. In order to best cater such interests, the real estate service may perform the lead allocation by identifying current the geographic position of the client, and then comparing that position against current geographic positions of agents in geographic proximity to the client. As discussed above, the geographic positions of the client and the agents may be determined using GPS or other location determining capabilities of the agents' or client's mobile devices.

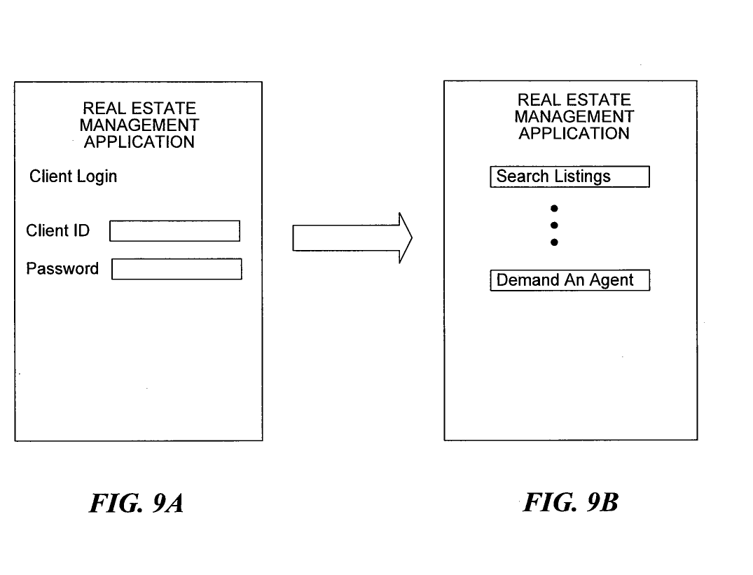

In some instances, the real estate service identifies a certain number of most proximate agents and relays the client's request to such agents. When one of the agents responds to the request, that agent is assigned to the client. In some instances, the service then informs the client about the assignment, and also, in some instances, indicates an expected arrival time of the agent at the client's present location based on the assigned agent's present location. In some instances, instead of basing the search on the client's present geographic position, the search may instead be based on a specific address provided by the client. The following discussion of FIGS. 9-11 illustrate this embodiment where the client is able to demand an agent based on present location.

FIGS. 9A and 9B illustrate a visual embodiment of a client user interface of the real estate application for demanding an agent based on present location. FIG. 9A represents such an interface, where a client is able to login or otherwise gain access to services offered by the real estate service. FIG. 9B represents an exemplary interface that allows the client to choose one of various services offered by the real estate service. For example, the client may be able to search property listings, or in some instances, be able to “demand an agent.” When the client activates such a feature, in some instances, the real estate service identifies a present location of the client. For example, the real estate service may utilize the GPS capabilities of the client's mobile device to identify the client's present location.

Subsequently, the real estate service searches for real estate agents in a geographic proximity to the client's location. In one embodiment, the real estate service may identify geographic positions of all its agents at the time the request was received, and identify an agent that is located closest to the client. Again, the real estate service may utilize the agents' mobile devices to identify their current locations. In some instances, the real estate service may search geographic positions of only those agents assigned to the general geographic location the request arises from. For example, the real estate service may only identify the present geographic location of agents who primarily operate from the San Francisco Bay Area (when the request is received from one of the cities in the Bay Area). In some instances, the real estate service may automatically assign the closest agent to the client. In some instances, the real estate service may ping the closest agent to determine availability, and if a negative response or no response is received, the real estate service may then send the request to the next “closest” agent, and so on, until an agent accepts the request.

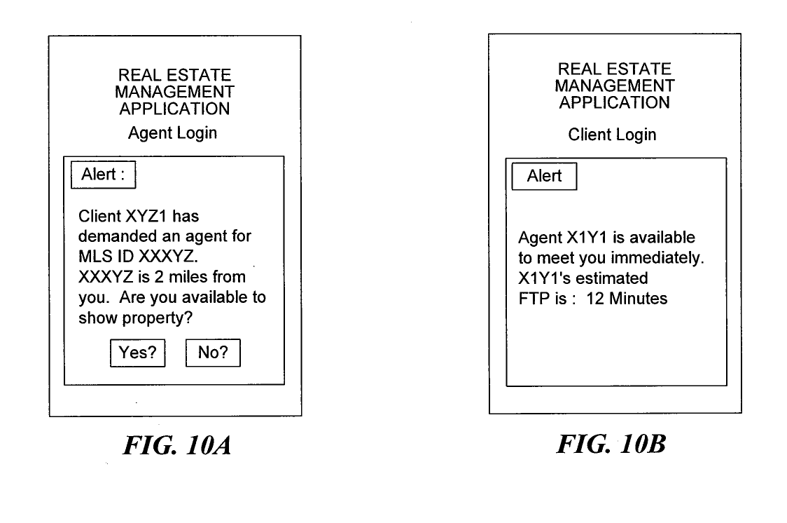

In some instances, the real estate service may send the client's request to a certain number of “closest” agents. For example, the real estate service may identify the top 10 agents located closest to the client's location. The first agent to respond is then assigned to the client. An illustration of such an embodiment is shown in FIG. 10A, where a request is sent to an agent's management application requesting the agent's acceptance (or denial) of the client's request. In some instances, as shown in FIG. 10A, the real estate service may also transmit information related to the client and the client's present location to assist the agent in making a suitable determination. In some instances, the real estate service may also identify an MLS property at or near the client's present location and transmit information regarding the MLS property to the assigned agent.

When an agent is assigned to the client, the real estate service transmits a message to that effect to the client. An example of such a message is illustrated in FIG. 10B. In some embodiments, in addition to sending information about the assigned agent, the real estate service may also indicate the agent's current location and/or the agent's estimated time of arrival at the client location. The real estate service may constantly or periodically update this information based on the agent's current location at periodic times and then transmit such updates to the client.

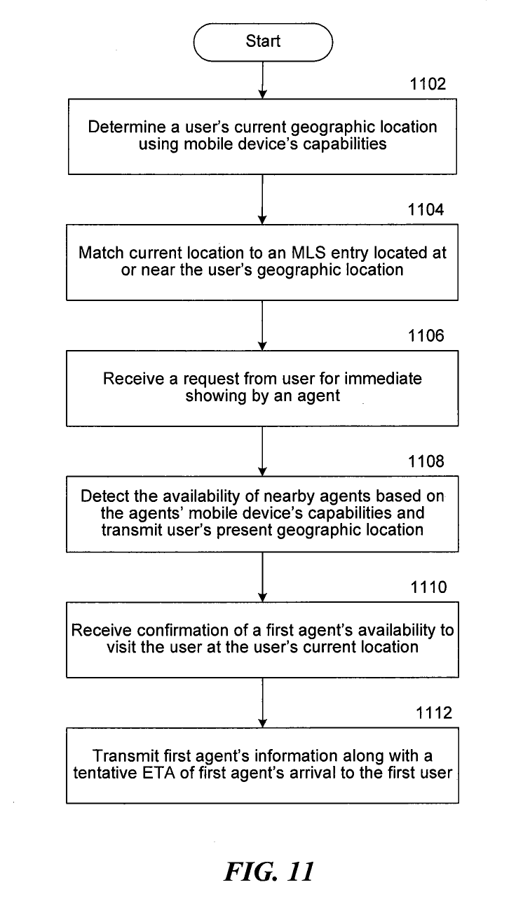

FIG. 11 is a flow diagram illustrating a process by which a client may demand an agent based on the client's present location. At step 1102, the real estate service determines the client's present geographic location. Subsequently, at step 1104, the real estate service may optionally identify an MLS location located at or near the client's present location. At step 1106, the real estate service receives a request from the client demanding an agent. It is reiterated here that the specific order of the sequence illustrated in FIG. 11 is not critical or essential to the operation of the methodologies discussed herein. At step 1108, the real estate service determines present locations of agents in geographic proximity and identifies one or more agents that may be able to be assigned to the client. At step 1108, the real estate service receives a confirmation from one of the agents and assigns that agent to the client. Finally, at step 1110, the real estate service transmits information about the assigned agent and, optionally, the ETA of the agent's arrival at the client's present location.

### Lead Allocation Based on Dynamic Calculation of Agent Allocation Weightage

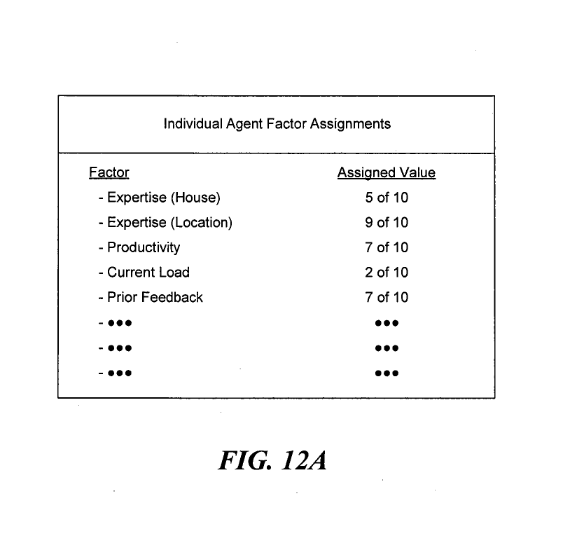

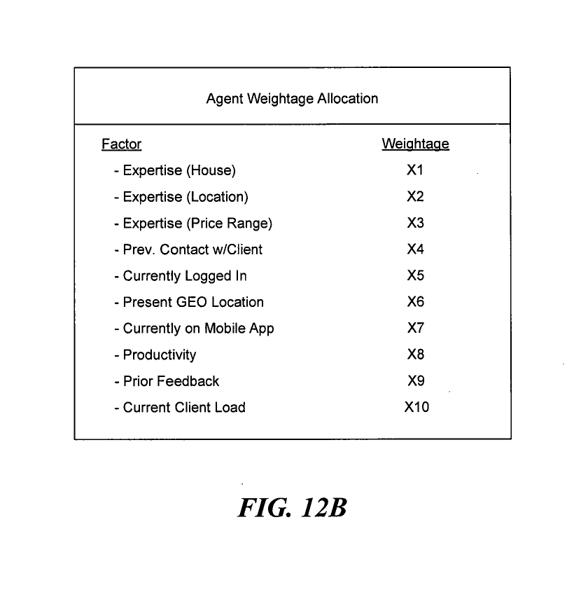

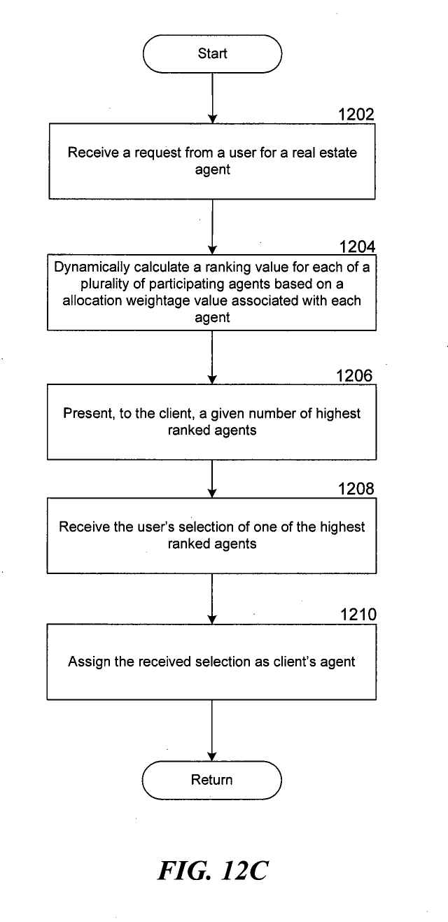

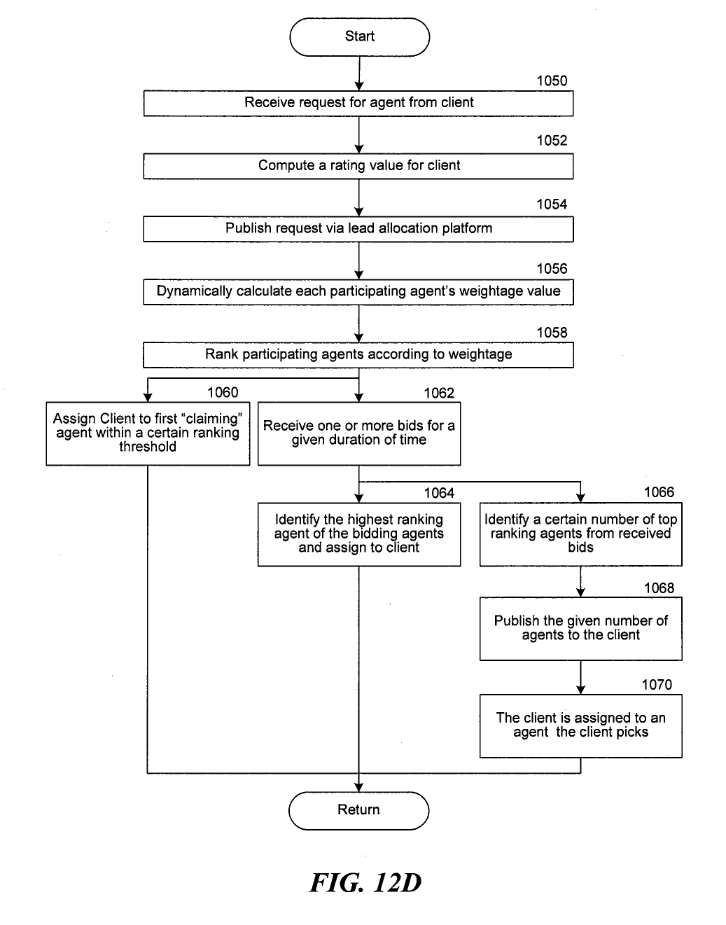

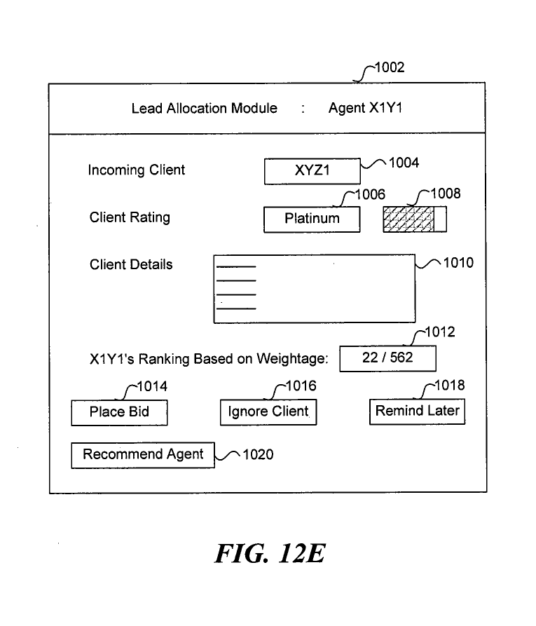

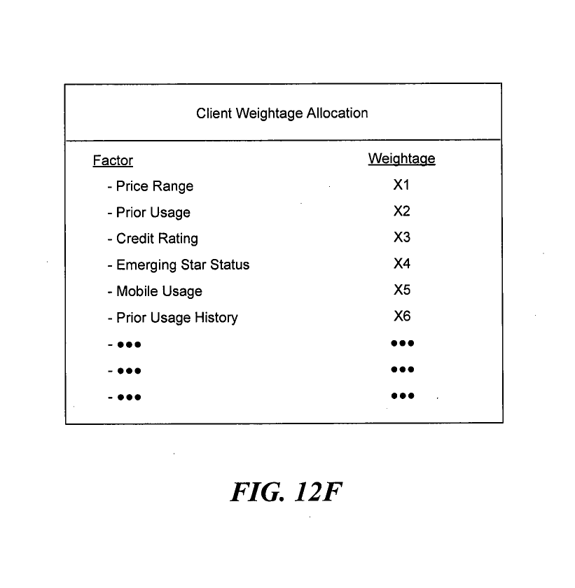

Another embodiment of the lead allocation methodologies discussed herein relates to dynamically assessing an allocation weightage of the real estate agents at the time an incoming client makes an agent request, and allocating an agent to the client based on a ranking of the allocation weightage. It is well known that each agent in a real estate service community comes with certain unique qualifications. Such qualifications could include expertise in specific factors (properties in a particular price range, properties in a particular location, etc.). While some qualifications may stay constant, other qualifications, such as expertise, current client load, etc. vary with time and need to be periodically assessed. Additionally, the qualification of a given agent may also vary with respect to client characteristics. For example, an agent fluent in Spanish may be better suited for a Spanish speaking client. Accordingly, when a client makes a request for an agent, efficient lead allocation may be accomplished by dynamically assessing the status or qualifications of the agents at the time the request is made, and allocating the most qualified agent according to the dynamic assessment. The following discussion of FIGS. 12A-12F illustrates several embodiments of accomplishing such dynamic lead allocation.

This section discusses exemplary illustrations for computing the allocation weightage for the clients. In some instances, the real estate service maintains a database of factor assignments for each individual agent. The factor assignments include multiple performance indicators associated with the client. Some such indicators are illustrated in FIG. 12A. The real estate service maintains scores for each of these performance indicators. The real estate service constantly maintains and updates scores for these performance indicators as and when an update occurs. In some instances, the scores are computed dynamically in relation to details associated with the incoming client. For example, an incoming client is interested in viewing homes in the Mountain View, Calif. locality.

One of the performance indicators relates to an agent's expertise in a particular location or particular price range. Accordingly, using profile history previously maintained for each agent, the real estate service computes a score chart for performance indicators for each agent. In the example shown in FIG. 12A, the agent scores high on location expertise, but does not have much experience showing a specific house the client may be interested in. Other such performance indicators may include, for example, the agent's current productivity level as indicated in the agent's performance evaluation (or other such sources), the agent's current load of clients (a higher load may indicate a lower score due to lack of bandwidth availability), presence of previous contact or communication with the incoming client, a new agent incentive (a higher value indicates a high incentive given to allow a new agent to be able to secure more clients), a score based on previous feedback provided by clients or peers, tracked usage of mobile device usage for accessing the real estate management service, etc. Other such performance indicators, as may be understood by one of ordinary skill in the art, may also be added to the list to assist the real estate service in calculating a weighted allocation for each client.

It is noted that the dynamic score computation and eventual weightage allocation may be performed for all agents associated with the real estate service. In some instances, depending on the local real estate market and a number of available real estate agents, such computations may be confined to a local geographic region (e.g., agents located in the Northern California region, etc.) in order to conserve computational resources.

Subsequent to dynamically calculating scores for performance indicators for each client, the real estate service may compute an overall allocation weightage or weighted aggregation of the scores. In some instances, the real estate service may simply apply equal weightage to all performance indicators and arrive at the allocation weightage by simply summing the various scores. In other instances, the real estate service may apply a weightage matrix to assign different weightage values to each individual performance indicator. Such an exemplary weightage allocation matrix is illustrated in FIG. 12B. Here, in examples, the expertise factors and the productivity factors may be given much higher weightage than the present geographic location and mobile login performance indicators. In some instances, the real estate service may pre-assign such weightage values for each performance indicator. In some instances, the real estate service may allow a client to pre-assign the weightage values for each performance indicator based on a personal preference of the client. For example, a client preferring an agent that has the least client load may apply a high weightage value (or complete weightage value) for that performance indicator relative to the remaining performance indicators.

Subsequently, using the dynamically computed scores for each agent, the real estate service computes an allocation weightage value for each client. Accordingly, this allocation weightage is a function of weighted values of various performance indicators associated with each client. The real estate service utilizes this dynamically computed allocation weightage to assign an appropriate agent to the client.

In one embodiment, the real estate service may simply rank the agents according to the allocation weightage values and assign the agent with the highest allocation weightage to the incoming client. In some instances, the real estate service may identify a certain top number of real estate agents according to the ranking and present information about such number of agents to the client. For example, the real estate service may identify the top five agents according to the dynamic ranking and present information about those agents to the client. The real estate service may also present the individual performance indicator scores or other relevant information about each agent to the client. The client may then be allowed to select one of those top ranking agents and subsequently be allocated to the selected agent. In some instances, the client may be allowed to select the number of top ranking agents she would like to see from the entire list (e.g., the client may be able to view a ranking of all the real estate agents associated with the service or simply the top 3). In some instances, the real estate service may limit the number of top rankers the client is allowed to choose from.

In some instances, the real estate service may display the highest ranking agent to the client and enable the client to either accept or reject the agent. Based on information about the agent, the client may accept or reject assignment to that agent. If the client accepts the displayed agent, the real estate service assigns the accepted agent to the client. If not, the real estate service displays the next-ranked agent to the client and requests acceptance or rejection. This process may continue until the client finally accepts a particular agent.

FIG. 12C is a flow diagram that depicts an example of the above methodology for lead allocation based on a ranking of allocation weightages associated with the agents. In one embodiment, at step 1202, the real estate service receives a request for lead allocation. In step 1204, the real estate service dynamically calculates an allocation weightage according to the methodologies described above. In one example, as shown in step 1206, the real estate service presents a list of top ranking agents to the client. At step 1208, the real estate service receives the client's selection of one of the displayed agents and subsequently (at step 1210) assigns the selected agent to the client.

### Virtual Lead Allocation Bidding Platform

In embodiments, the real estate service offers a virtual allocation platform to the real estate agents, allowing the agents to bid for an incoming client. In embodiments, the real estate service computes a ranking of the real estate agents and allows the real estate agents to bid for an incoming client. The real estate service evaluates a bid as a function of the allocation weightage (and corresponding ranking) of the agent and processes the bids in one of several ways. In some instances, the real estate service collects bids for a certain duration of time (e.g., 30 minutes after receiving the client request). The real estate service collects the bids and allocates the client to the bidder with the highest allocation weightage. In some instances, the real estate service may enable only a certain percentage of the real estate agents to bid for the client (e.g., only the top 25% of the ranked real estate agents are allowed to bid) and assign the client to the first bidding agent within that percentage.

In some instances, the real estate service may establish a tiered bidding structure. In such a tiered structure, for example, the real estate service may first open up bidding for a top percentage of ranked agents for a certain duration of time (e.g., top 20% for the first 20 minutes after receiving request from incoming client). If no bids are received within the first 20 minutes, the real estate service may open up bidding for a second percentage of ranked agents for a certain duration of time (e.g., top 50% of the ranked agents are allowed to bid for the next 20 minutes). This process continues until one or more satisfactory bids are received for further evaluation by the real estate service.

FIG. 12D is a flow chart depicting an exemplary process for allocating leads utilizing the virtual lead allocation methodologies discussed above. At step 1050, a client makes a request to be assigned to an agent. At step 1052, the real estate service computes a rating value for the client, which will be explained in further detail below. At step 1054, the real estate service publishes a request to the agents to bid for assignment to the incoming client. At step 1056, the real estate service dynamically computes an allocation weightage for each real estate agent. At step 1058, the real estate service ranks the agents according to the allocation weightage. Subsequently, there are at least three processes by which the bids are further evaluated. A first option, shown in step 1060, simply accepts a first bid and assigns the bidding agent to the client. In some instances, the real estate service verifies that the bidding agent is within a certain threshold (e.g., top 25%) of the ranking before accepting the bid. In a second option, shown in steps 1062-1064, the real estate service bids for a certain duration of time and accepts the bid with the highest ranking of the bids collected within the time duration. In a third option, shown in steps 1066-1070, the real estate service accepts bids from the real estate agents and publishes requests from a top percentage of the bidding agents to the client. The real estate service then assigns the client to a bidding agent selected by the client.

FIG. 12E is an example of a virtual platform 1002 of the real estate service management application that enables an agent to place a bid according to the methodologies discussed above. In embodiments, the virtual platform 1002 represents information about an incoming client for whom the bid is solicited. The virtual platform 1002 includes details about the incoming client 1004, and an internal client rating 1006. In some instances, it may be useful for the agent to understand a client's potential value in making a decision on whether to bid for the incoming client. In examples, the client rating may be assigned by the real estate service based on a number of weightage factors associated with the client. Examples of such client weightage factors are illustrated in FIG. 12F. For example, the client could be rated based on factors such as price range the client is looking for, client's prior history with the real estate service, client's credit rating, client's status as an emerging star, client's mobile usage history, etc. In embodiments, the client's rating is assigned a particular rating (e.g., a platinum rating or a particular score value) as represented in blocks 1006 or 1008 of FIG. 12E.

The virtual platform 1002 may further include detailed information 1010 about the client. In embodiments, the virtual platform 1002 may also include the particular agent's ranking 1012 based on dynamically calculated allocation weightage. In embodiments, the virtual platform may then present options for the agent to place a bid 1014, ignore the request 1016, remind the agent later 1018, or even recommend another agent 1020 that the agent may think may be better suited for the incoming client.

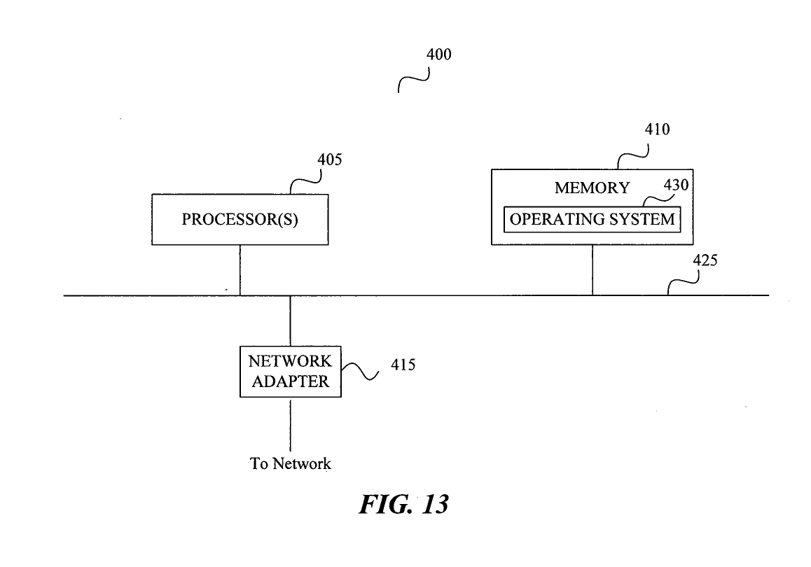

FIG. 13 is a high-level block diagram showing an example of the architecture for a computer system 400 that can be utilized to implement an agency server (e.g., 114 from FIG. 1), a web server (e.g., 125 from FIG. 1), a computing device (102, 104), etc. In FIG. 4, the computer system 400 includes one or more processors 405 and memory 410 connected via an interconnect 625. The interconnect 425 is an abstraction that represents any one or more separate physical buses, point to point connections, or both connected by appropriate bridges, adapters, or controllers. The interconnect 425, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineer (IEEE) standard 694 bus, sometimes referred to as “Firewire”.

The processor(s) 605 may include central processing units (CPUs) to control the overall operation of, for example, the host computer. In certain embodiments, the processor(s) 405 accomplish this by executing software or firmware stored in memory 410. The processor(s) 405 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 410 is or includes the main memory of the computer system 1100. The memory 410 represents any form of random access memory (RAM), read-only memory (ROM), flash memory (as discussed above), or the like, or a combination of such devices. In use, the memory 410 may contain, among other things, a set of machine instructions which, when executed by processor 405, causes the processor 405 to perform operations to implement embodiments of the present invention.

Also connected to the processor(s) 405 through the interconnect 425 is a network adapter 415. The network adapter 415 provides the computer system 400 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method for assigning a client to one of a plurality of real estate agents associated with a real estate service, the method comprising:
receiving a request from a client to get assigned to one of the plurality of real estate agents associated with the real estate service;
identifying the client's current geographic position;
identifying a given real estate agent of the plurality of real estate agents that is proximate in distance to the client's geographic position; and
assigning the given real estate agent to the client.

2. The method of claim 1, wherein identifying the client's current geographic position further comprises identifying geographic coordinate information associated with the client's mobile device.

3. The method of claim 1, wherein the step of identifying the given real estate agent further comprises:
identifying geographic coordinate information associated with at least a subset of the plurality of real estate agents;
calculating a distance between the geographic coordinate information associated with each of the plurality of real estate agents and a geographic coordinate information associated with the client the client;
identifying a particular real estate agent with the least calculated distance.

4. The method of claim 1, wherein the step of assigning the given real estate agent to the client further comprises:
transmitting the request from the client to one or more real estate agents determined to be proximate in distance to the client's current geographic position;
receiving an indication of acceptance of request from a first real estate agent of the one or more proximate real estate agents;
transmitting the indication of acceptance to the client.

5. The method of claim 4, further comprising:
matching the client's current location with a specific MLS-listed property located at or near the client's current geographic position;
transmitting information associated with the specific MLS-listed property to the first real estate agent subsequent to receiving the indication of acceptance of request from the first real estate agent.

6. The method of claim 1, further comprising:
receiving, in addition to the request to get assigned to an agent, a tour-request for immediate showing of a property located at or near the client's current geographic position;
matching the client's current location with a specific MLS-listed property located at or near the client's current geographic position;
transmitting information associated with the specific MLS-listed property to the given real estate agent.

7. The method of claim 6, further comprising:
computing, based on the given real estate agent's current geographic position, an approximate time of travel between the given real agent's current geographic position and the client's geographic position;
transmitting, to the client, information associated with the approximate time of travel for the given real estate agent to arrive at the client's geographic position.

8. The method of claim 7, further comprising:
periodically identifying an updated geographic position of the given real estate agent;
periodically transmitting, to the client, an updated approximate time of travel for the given real estate agent to arrive at the client's geographic position.

9. A method for assigning a client to one of a plurality of real estate agents associated with a real estate service, the method comprising:
receiving a request from a client to tour a property associated with the client's current geographic position by one of the plurality of real estate agents associated with the real estate service;
identifying the client's current geographic position based on geographic coordinates associated with the client's mobile device;
matching the client's current location with a specific MLS-listed property located at or near the client's current geographic position;
transmitting information associated with the client's current location and/or the specific MLS-property to a subset of the plurality of real estate agents that are determined to be located within a predetermined distance relative to the client's current geographic position;
receiving an acceptance from a first real estate agent of the subset of the plurality of real estate agents;
assigning the first real estate agent to the client; and
transmitting a confirmation message and information associated with the first real estate agent to the client.

10. The method of claim 9, further comprising:
computing, based on the first real estate agent's current geographic position, an approximate time of travel between the first real agent's current geographic position and the client's geographic position;
transmitting, to the client, information associated with the approximate time of travel for the first real estate agent to arrive at the client's geographic position.

11. A system for tracking a real estate agent's property visits, the system comprising:
a processor;
a memory configured to store a set of instructions, which when executed by the processor cause the system to perform a method, the method including:
receiving a request from a client to get assigned to one of the plurality of real estate agents associated with the real estate service;
identifying the client's current geographic position;
identifying a given real estate agent of the plurality of real estate agents that is proximate in distance to the client's geographic position; and
assigning the given real estate agent to the client.

12. The system of claim 11, wherein identifying the client's current geographic position further comprises identifying geographic coordinate information associated with the client's mobile device.

13. The system of claim 11, wherein the step of identifying the given real estate agent further comprises:
identifying geographic coordinate information associated with at least a subset of the plurality of real estate agents;
calculating a distance between the geographic coordinate information associated with each of the plurality of real estate agents and a geographic coordinate information associated with the client the client;
identifying a particular real estate agent with the least calculated distance.

14. The system of claim 11, wherein the step of assigning the given real estate agent to the client further comprises:
transmitting the request from the client to one or more real estate agents determined to be proximate in distance to the client's current geographic position;
receiving an indication of acceptance of request from a first real estate agent of the one or more proximate real estate agents;
transmitting the indication of acceptance to the client.

15. The system of claim 14, wherein the method further comprises:
matching the client's current location with a specific MLS-listed property located at or near the client's current geographic position;
transmitting information associated with the specific MLS-listed property to the first real estate agent subsequent to receiving the indication of acceptance of request from the first real estate agent.

16. The system of claim 11, wherein the method further comprises:
receiving, in addition to the request to get assigned to an agent, a tour-request for immediate showing of a property located at or near the client's current geographic position;
matching the client's current location with a specific MLS-listed property located at or near the client's current geographic position;
transmitting information associated with the specific MLS-listed property to the given real estate agent.

17. The system of claim 16, wherein the method further comprises:
computing, based on the given real estate agent's current geographic position, an approximate time of travel between the given real agent's current geographic position and the client's geographic position;
transmitting, to the client, information associated with the approximate time of travel for the given real estate agent to arrive at the client's geographic position.
